(19) United States
(12) Patent Application Publication
(10) Pub. No.: US 2003/0006888 A1
(43) Pub. Date: Jan. 9, 2003

(54) Vehicle-mounted mirror-integrated radar system

(76) Inventors: Robert L. Burchette JR., Chesnee, SC (US); Frank Micali, Boca Raton, FL (US)

Correspondence Address: DORITY & MANNING, P.A., POST OFFICE BOX 1449, GREENVILLE, SC, 29602-1449, US

(21) Appl. No.: 10/190,306

(22) Filed: Jul. 5, 2002

Related U.S. Application Data
(60) Provisional application No. 60/303,303, filed on Jul. 6, 2001.

(51) Int. Cl. G08G 1/00

(52) U.S. Cl. 340/425.5; 340/901; 340/438; 340/691.6

(57) ABSTRACT

A modular assembly is disclosed for mounting within a vehicle interior and for providing a plurality of electronic accessories to a user. Such integrated assembly preferably includes a system for detecting radar signals and providing audio and visual alerts upon detection of selected signals. An assembly may also include additional electronic accessories such as digital display, home access control, digital voice recorder, cellular phone, and audio interface. Such digital display may provide a user with an informative status of temperature, time, direction, or other selected quantities. Such audio interface preferably includes at least one microphone for audio input and at least one speaker for audio output. The modular assembly is preferably designed as a retrofit product for installation in a vehicle and for integration with certain existing vehicular technology. Such assembly is most preferably integrated with existing circuitry and function of a typical rearview mirror for a vehicle, but other integration options are provided.

### PRIORITY CLAIM

This application claims the benefit of previously filed U.S. Provisional Patent Application entitled “VEHICLE-MOUNTED MIRROR-INTEGRATED RADAR SYSTEM,” assigned U.S. S No. 60/303,303, filed Jul. 6, 2001, and which is incorporated herein by reference for all purposes.

### BACKGROUND OF INVENTION

The present subject matter generally relates to a rearview mirror having integrated electrical accessories for use in a vehicle. More specifically, the present subject matter concerns such a vehicle-mounted mirror-integrated module that includes a radar system and other electronic accessories.

Today's developing technology yields many electronic devices that people frequently use and have come to depend on. Such electronic devices offer various unique capabilities, and many of these provide convenient function in the context of automobiles or other vehicular crafts. Certain electronic accessories that may provide the user of a vehicle with added convenience may include radar detectors, display information or hands-free cell phone adapters.

Such electronic accessories are typically purchased separately, but many of them are incorporated with vehicular use. The existence of a plurality of varied electronic accessories within the confines of a vehicle can lead to cramped, uncomfortable, and sometimes hazardous driving conditions. As the number of such devices increases, the amount of space available to a driver decreases. Thus, the need arises for an integrated assembly of electronic components that offer beneficial functionality to a driver.

Certain devices require strategic positioning within a vehicle to offer the most benefit to a user. For instance, rearview mirrors are typically located relative to a driver's line-of-sight in order to provide convenient display for the driver. Other devices are often positioned near a vehicle's rearview mirror in order to take full advantage of such preferable location.

Similarly, interactive devices such as a radio or air conditioner controller are positioned to be in a directly accessible path for a driver's hands. Poor positioning of driver-interactive devices have been the cause of many accidents on the road. For instance, in order to use a cellular phone, a driver has to divert his or her attention from the road and focus on the road to plug the phone into a source (if necessary), turn the phone on, dial the number and send the call. Likewise, if there is an incoming call, the driver has to divert his or her attention to locate the phone and answer the call. Time spent concentrating on the cell phone and not on driving leaves ample opportunity for accidents.

It may often be ideal for several electronic accessories used in a vehicle to be combined into a single device that can be integrated into existing vehicular technology. Such modular assemblies are often sold as aftermarket products for installation in a vehicle. It is known in the art of retrofit electronic assemblies that existing electrical connections or power sources in a vehicle may be utilized to power such assemblies.

While examples of various aspects and alternative embodiments are known in the field of retrofit electronic accessories for use in a vehicle, no one design is known that generally encompasses all of the above-mentioned ideal characteristics.

U.S. Pat. No. 4,625,210 shows an example of a portable radar detector that also functions as a mirror. In this device a mirror covers the front and back faces of the radar.

U.S. Pat. No. 5,455,716 discloses an exemplary vehicle mirror that has a variety of electrical accessories. Options in the context of the subject design may include a temperature gauge, garage door opener, compass, map light, light control, lock control and alarm control.

U.S. Pat. No. 6,124,886 is directed to a modular rearview mirror assembly. This device incorporates integrated subassembly modules connected to electrical components. Integral support, such as electrical connections, is provided for electrically operated features.

Additional patents that provide varied examples of rearview assemblies with combined electronic features are disclosed in U.S. Pat. No. 4,630,904, U.S. Pat. No. 4,917,477, U.S. Pat. No. 4,943,796, U.S. Pat. No. 5,481,409, U.S. Pat. No. 5,631,638, and U.S. Pat. No. 5,684,488. Mounting accessories for rearview mirrors and associated display elements are described in U.S. Pat. Nos. 4,760,497, 4,930,742, and 5,014,947.

The disclosures of all of the foregoing United States patents are hereby fully incorporated into this application by reference thereto.

### SUMMARY OF THE INVENTION

In view of the discussed drawbacks and other shortcomings encountered in the prior art, and recognized and addressed by the present invention, an integrated vehicle-mounted electrical system has been developed. Thus, broadly speaking, a general object of the present invention is an improved vehicle-mounted mirror-integrated module that includes a radar system.

It is another general object of the present invention to provide a vehicle-mounted device that conveniently provides various electronic accessories for the user of a vehicle.

It is a principle object of the present invention to provide a radar system that also includes additionally desired electronic components in combination to form a multi-function electronic assembly.

It is another object of the present invention to provide a modular assembly suitable for retrofit installation within a vehicle and easily combined with existing technology of a vehicle interior.

It is an additional object of the present invention to provide a design system that is safe and convenient for the user. The device of the present invention ideally includes interactive and display elements that are strategically located for the convenience of the driver.

Additional objects and advantages of the invention are set forth in, or will be apparent to those of ordinary skill in the art from, the detailed description herein. Also, it should be further appreciated that modifications and variations to the specifically illustrated, referenced and discussed features hereof may be practiced in various embodiments and uses of this invention without departing from the spirit and scope thereof, by virtue of present reference thereto. Such variations may include, but are not limited to, substitution of equivalent means and features for those illustrated, referenced or discussed, and the functional, operational or positional reversal of various parts, features or the like.

Still further, it is to be understood that different embodiments, as well as different presently preferred embodiments, of this invention may include various combinations or configurations of presently disclosed features or elements, or their equivalents (including combinations of features or parts or configurations thereof not expressly shown in the figures). One exemplary embodiment of the present subject matter relates to a modular assembly generally suited for retrofit installation within a vehicle. Such modular assembly provides a vehicle user with various components integrated together and includes both display elements positioned in convenient line of sight for a driver and interactive elements with facilitated potential for manual user interaction. The electronic components of such a modular assembly may preferably be powered by existing power sources within a vehicle, or may alternatively be powered by supplemental sources such as a battery.

One exemplary embodiment of the presently disclosed technology concerns a mirror-integrated module for mounting within a vehicle. Such a module preferably comprises a rearview mirror provided in conjunction with a mirror reflectivity mechanism and a radar detector. The mirror reflectivity mechanism is preferably configured to adjust the reflectivity level of the rearview mirror based on the amount of ambient light provided thereto, and in some embodiments comprises a photocell. The radar detector is configured to receive and process RF signals, such as X-band, K-band, and/or Ka-band signals, and subsequently provide output to a user based on selected of such RF signals. The mirror-integrated module may further include a home access controller for outputting signals to provide access to a home entrance, and in some instances may be programmed to output known frequencies for opening a garage door.

Yet another exemplary embodiment of the present subject matter corresponds to a multi-function electronic assembly for integrating with a rearview mirror in a vehicle interior. Such electronic assembly may comprise a mirror reflectivity mechanism, a radar detector, a digital display, a speaker, and a home access controller. The radar detector provides an output based on a predetermined range of RF signals it is configured to receive. The speaker preferably provides an audio output upon detection of selected RF signals by the radar detector, and the digital display preferably provides a visual output upon detection of selected RF signals by the radar detector. In certain exemplary embodiments, the digital display is further configured to output information such as that corresponding to current time, current temperature, vehicle location, vehicle direction, vehicle speed, and/or vehicle fuel level.

A still further exemplary embodiment of the subject technology concerns a modular assembly suitable for retrofit installation within a vehicle, and may comprise a rearview mirror, a mirror reflectivity mechanism, a radar detector, a digital display, a speaker, a home access controller, and an audio recorder. The audio recorder preferably receives input from a microphone audio input and is capable of storing audio signals provided thereto. Such stored audio signals may also be subsequently outputted by the speaker component of the modular assembly. Such microphone component may also be interfaced in some embodiments with the audio recorder and the home access controller such that voice commands inputted to the microphone effect accessibility to a home entrance, such as a garage or home door. A modular assembly in accordance with the disclosed technology may further include an electrical interface for connecting with a cellular phone whereby hands-free cellular communication for the user is facilitated via the microphone and speaker components.

Additional embodiments of the present subject matter, not necessarily expressed in this summarized section, may include and incorporate various combinations of aspects of features, components, or steps referenced in the summarized objectives above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is an illustration of exemplary electronic accessories for selection in a retrofit assembly in accordance with the present subject matter.

FIG. 2a is a generally front view of a first exemplary embodiment of a retrofit electronic assembly in accordance with the present subject matter.

FIG. 2b is a generally front view of a second exemplary embodiment of a retrofit electronic assembly in accordance with the present subject matter.

FIG. 3 is a generally front view of the interior of a vehicle as seen from a passenger's perspective, incorporating exemplary display positions and power options for an electronic assembly in accordance with the present subject matter.

FIG. 4 is an illustration of an exemplary cellular phone accessory for incorporation with aspects of the subject technology in accordance with the present disclosure.

Repeat use of reference characters throughout the present specification and appended drawings is intended to represent same or analogous features or elements of the subject invention.

### DETAILED DESCRIPTION OF THE DRAWINGS

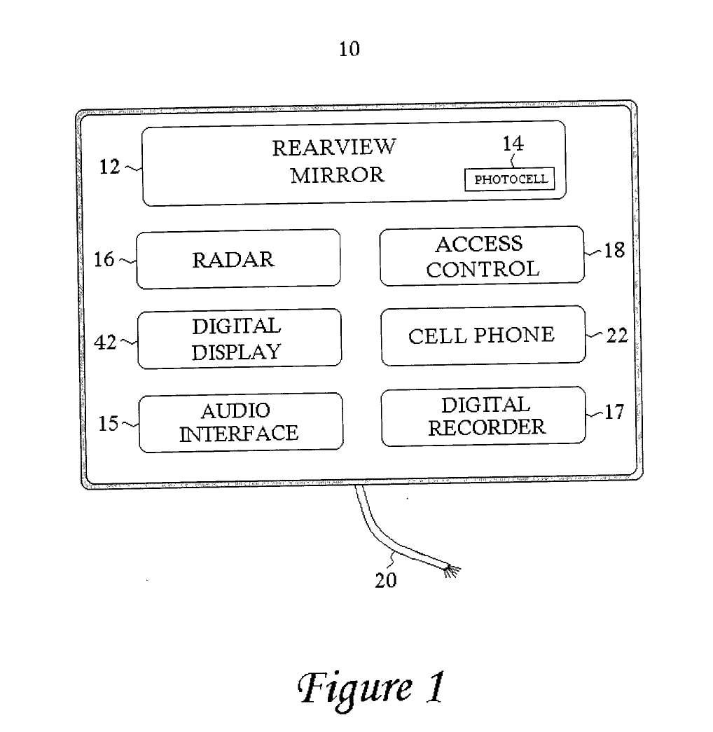

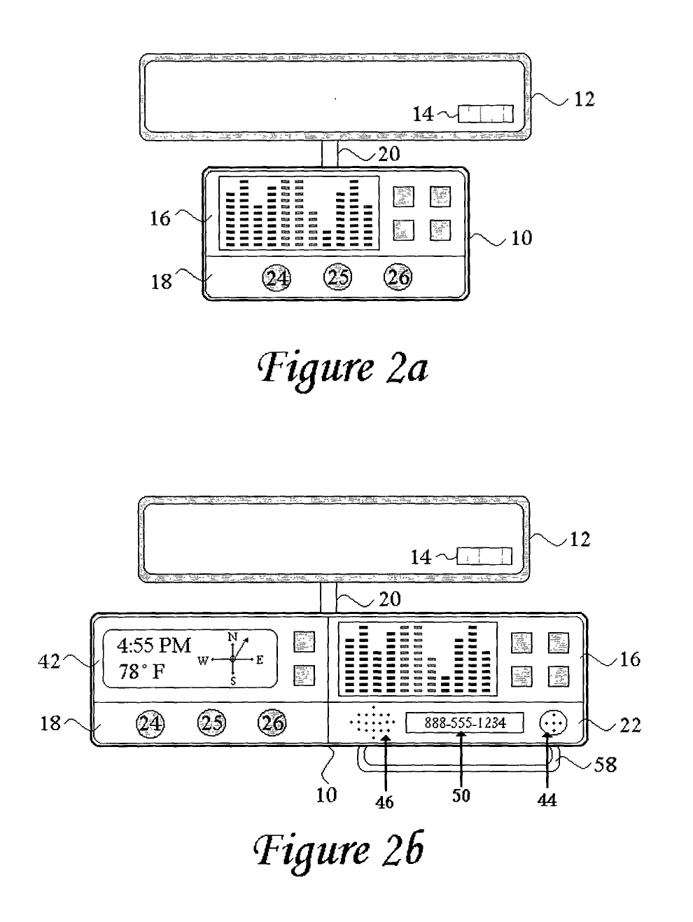

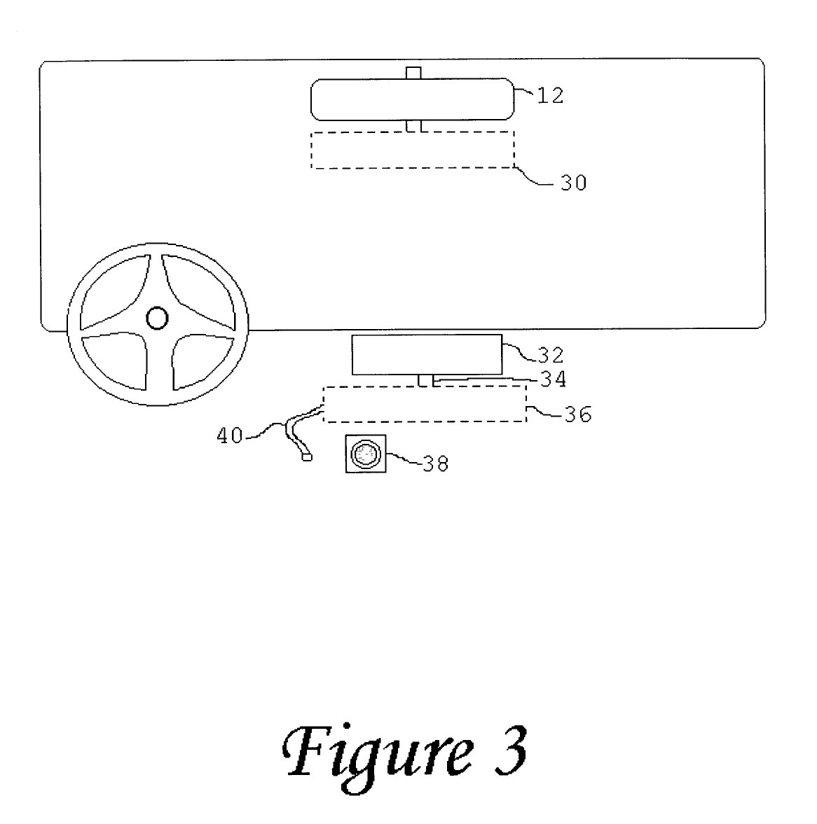

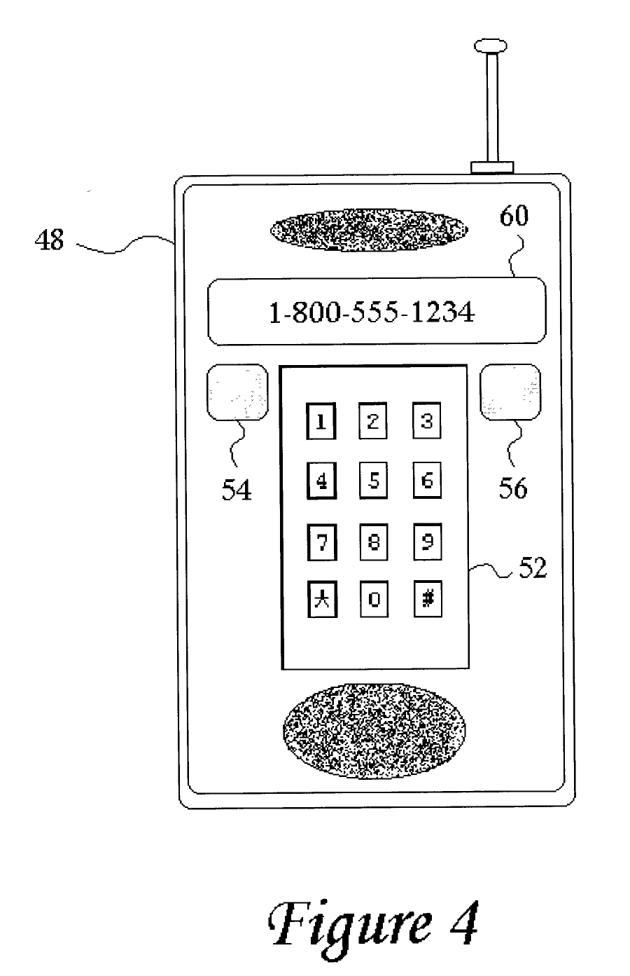

As discussed in the Summary of the Invention, the present invention is concerned with a vehicle-mounted mirror-integrated module that includes a radar system and other electronic accessories. The selection of accessories for inclusion in such an integrated electronic assembly may be varied according to customer preference or other appropriate combination of elements. A block diagram depicting exemplary accessories for use in a vehicle-mounted module in accordance with the present subject matter is displayed in FIG. 1. Exemplary embodiments of this module featuring selected electronic accessories in combination are illustrated in FIGS. 2a and 2b. FIG. 3 displays the different preferable locations and power options that are possible with a retrofit device of the present invention within a vehicle. FIG. 4 relates to an exemplary cellular phone accessory for potential incorporation with the subject retrofit assembly.

Referring now to the drawings, FIG. 1 is an illustration of an exemplary retrofit assembly of the present invention. A retrofit electronic assembly 10 is ideally created for installation after the manufacturing of a vehicle. The assembly 10 is preferably designed to be mounted within a vehicle interior. As shown, several accessories may be incorporated into assembly 10. A user may ideally select a combination of various components for such integrated electronic assembly 10. An assembly 10 may comprise a rearview mirror 12, mirror reflectivity mechanism 14, radar system 16, home access control 18, digital display 42, cell phone accessory 22, audio interface 15 and digital recorder 17. A more detailed description of each of these elements and suggested features thereof in accordance with the present subject matter follows.

In general, mirror 12 provides the same functionality as a typical rearview mirror. Specifically, the location and surface area of mirror 12 are generally similar to that of a standard rearview mirror. Thus mirror 12 ideally offers the same visual range and convenience to the driver as would a typical rearview mirror for a selected vehicle type. It may be ideal for the rearview mirror to be included in assembly 10. If mirror 12 is not included in the assembly 10, assembly 10 can be placed near an existing rearview mirror in a vehicle to offer the same convenient location for a driver.

Photocell 14 is a preferred embodiment of a light reflectivity adjusting mechanism for use in accordance with mirror 12. Photocell 14 provides a way to automatically adjust the light reflectivity level of mirror 12 to provide a desirable level of reflectivity to a driver. Ambient light is typically the decisive input to photocell 14 and the output is a correspondingly calculated level of mirror reflectivity. Depending on the amount of ambient light that a mirror is exposed to, internal circuitry of a photocell adjusts a variable resistance and the amount of light let through the mirror to a desired level. Therefore, by using an automatic adjusting means such as a photocell, the amount of light being reflected from a mirror is directly determined by the amount of light that is shining into the mirror.

Another option for adjusting mirror reflectivity could be a manual light reflectivity adjusting mechanism that flips between varied levels of reflectivity. In this case, the driver would “flip” the rearview mirror to a different angle to control the reflectivity of the mirror. This manual reflectivity adjusting means would achieve the same goal as the automatic light reflectivity adjusting means. The need for driver interaction with a manual adjusting means may constitute the photocell as a preferred option.

A radar system 16 is preferably included in constructed embodiments of the subject assembly 10. Radar detector system 16 is configured to receive a signal, further process the received signal, and provide an output based on that signal. Various radar detector components available in the marketplace may be used in accordance with the invention. For example, a radar detector for use in the present invention might be manufactured by and properly licensed under the Whistler brand by Whistler Corporation of Massachusetts. Generally, radar detector 16 is capable of receiving a signal ranging from an X-band signal (10.5-10.55 GHz) to a K-band signal (24.05-24.25 GHz). Preferably, radar detector 16 is configured to receive a Ka-band signal (33.4-36 GHz). Ka band radar guns are being used more frequently than X or K band radar guns by police due to their compact size and other high-tech features. In addition, radar detecting means 16 has “360° total perimeter protection” meaning that signals can be detected from any direction. After radar detector 16 receives a signal, the signal is processed and the type of signal is determined. During processing, the bands of radar that produce false alerts are preferably filtered. The output that is generated after processing alerts the driver if any precautions need to be taken (such as reducing the speed of the vehicle). One option for radar detector system 16 would be to inform the driver of the location of the signal (such as distance from the signal) and also the strength of the signal. Another option would be for radar detector 16 to alert the driver to potential road hazards, adverse weather or location of emergency vehicles. The output to the driver can be an audio alert, a visual alert or both. Typically, visual signals may be digitally displayed using a LED (light emitting diode) or a LCD (liquid crystal display). Audio alerts may be outputted through a speaker incorporated with assembly 10 or through existing audio outputs in a vehicle, such as a speaker connected to an existing radio assembly.

Alternatively radar system 16 may be a laser-based system, comprised of components available in the marketplace. Still further, such component 16 may include “jamming” technology (where not banned legally) for blocking associated signals (laser or RF-based) attempting to monitor users of the present subject matter.

Home access control 18 is another electronic accessory that can be integrated into assembly 10. In one embodiment, home access control 18 includes a garage door opener. In more specific embodiments, such as those shown in FIGS. 2a and 2b, home access control 18 has three buttons. Such three buttons 24, 25 and 26 could be programmed to correspond to an owner's garage, a significant other's garage and to an owner's house. In general, in order for home access control 18 to open a garage door (or the door to a house), a specific frequency has to be transmitted. There is a receiver positioned near the garage door (or near the door of a house) that monitors a range of frequencies. The receiver specifically looks for the frequency that is transmitted by home access control 18. Home access control 18 generates a signal at a preprogrammed frequency, which the receiver obtains. After the receiver obtains the specific predetermined frequency, the garage door (or the door to a house) automatically opens.

In order for an existing door opener to be incorporated into home access control 18, a predefined process of “teaching” a button function must occur. First, the frequency of the signal that the existing door opener generates must be determined. This may typically be done by holding an existing remote door opener near home access control 18. Upon activation of an existing door opener, the transmitted frequency is obtained by an appropriate signal receiving means in home access control 18. After the frequency is received, it is programmed into storage means in the home access control 18. Ideally, once the frequency has been stored, a selected button 24, 25 or 26 can transmit the same frequency as an existing remote door opener and provide effective home access.

Digital display 42 is another feature that may potentially be included in modular assembly 10. A digital display 42 may include a variety of different pieces of information, including location, time, temperature or other data that may be of use to a vehicular operator. Display 42 preferably includes a compass feature that would let the driver know the exact direction of travel. In addition to specifying the direction of travel, a compass feature might inform the driver of his/her relative location, similar to information provided by a GPS unit. Additional embodiments of electronic assembly 10 might be characterized by a digital display 42 that provides more information than merely direction. A typical example might be a digital display 42 that includes a compass, a temperature display and a time display. This would allow the driver to know direction, location, internal or external vehicle temperature, time or other displayed information. Display 42 could easily output any number of additional indicators that provide essential information to a driver. Such information might also include warning lights to indicate low fluid levels in a vehicle. The electronic components of the digital display may preferably be chosen based on specific customized designs.

Assembly 10 may additionally include a cell phone accessory 22 to provide a driver with convenient wireless communication capabilities. The cell phone accessory may correspond to two general embodiments. A first embodiment provides all typical functions of a cellular phone. An alternative embodiment simply provides an interface for hands-free cell phone use with an existing cellular phone. If assembly 10 includes a complete cellular phone accessory, then cell phone component 22 would preferably include all elements and functionality of a cell phone, such as the exemplary cell phone 48 shown in FIG. 4. Cell phone 48 typically contains a number of standard features, including a digital display 60, keypad 52, and other functional buttons 54 and 56. Digital display 60 typically shows the number to be dialed and the length of time for each call. In other embodiments of cell phone 48, digital display 60 might show caller identification to inform the user of the person's number who is calling or of other information. Keypad 52 is typically used to dial a phone number or input some other essential information. Common functional buttons include a send button 54 which may be used to initiate a phone call and end button 56 which may be used to terminate a phone call.

An audio interface comprising at least speaker and microphone components is also essential to cell phone accessory 22. These components are provided for either a complete cell phone embodiment or a hands-free cell phone adapter embodiment. Such a speaker 46 and microphone 44 for hands-free cell phone implementation are depicted in FIG. 2b. In order to utilize an existing cellular phone, a cradle or other means for providing electrical connection to such cell phone is provided by connective element 58. Additional elements of a typical cell phone may also be provided in cell phone accessory 22, even if an existing cell phone is used in combination with accessory 22. For instance, an additional digital display 50 would provide a driver with similar information as provided on digital display 60 in FIG. 4. The speaker and microphone components may be included as part of cell phone accessory 22 or existing speaker components in a vehicle may be alternatively utilized. Speaker and microphone components for use with cellular phone accessory 22 may also be incorporated into audio interface component 15.

The provision of an audio interface 15 for use in assembly 10 may be utilized with many more accessories than just cell phone 22. The major components of such audio interface 15 would be a microphone for audio input and a speaker for audio output. A speaker such as 46 in FIG. 2b could be used in accordance with home access control system 18. For example, a garage door opener can be configured so that it is voice activated. This would allow the driver to simply say a word or phrase, instead of pushing a button, to open the garage door. The speaker of audio interface 15 may provide a driver with predetermined audio alerts corresponding to output of radar detector system 16. Such a speaker may also be used in conjunction with digital display 42. The press of a button could output selected of the information already displayed visually by component 42. Multiple buttons could be provided such that a single button corresponds to a particular piece of information, such as a button for audio output of each of location, time and temperature. Alternatively, a single button could scroll through varied audio outputs. This information could be outputted through a speaker included in audio interface 15 or through an existing radio or other speaker in a vehicle.

Audio interface 15 may also be used in direct combination with digital recorder 17. The provision of a speaker, microphone and storage memory would facilitate a digital recorder for many applications. This combination of audio equipment could be used to record voice memos, reminders, phone numbers and other important information. Such combination of elements might also used in combination with cell-phone accessory 22 to provide voice-activated dialing.

Consider using cell phone accessory 22 in combination with audio interface 15 to place a hands-free call. If cell phone accessory 22 is not a complete cell phone, then an existing cell phone must be electrically connected to assembly 10, such as through cradle connector 58. A selected button will be pressed to initialize voice-activated cell phone use. Then, once a user speaks a given word, phrase or number into a microphone, such as 44 in FIG. 2b or a microphone provided by audio interface 15, the cell phone will automatically dial the selected phone number. For instance, if a driver wants to call his/her office, all he/she has to do is project a predetermined word or phrase into microphone 44 and the appropriate number is automatically dialed. Of course, dialing the number manually is still an option. Manual dialing can be effected through dialing a number on an existing keypad, such as keypad 52 in FIG. 4. A remote dialing pad may also be provided for use in accordance with cell phone accessory 22 for additional convenience to a user.

As previously mentioned, existing audio input or output in a vehicle may be utilized instead of audio interface 15. In particular, an existing speaker connected to a radio or other musical accessory could be used instead of speaker 46 in FIG. 2b. These two alternative audio outputs may also be used in conjunction with one another to provide a balanced audio environment. Several different audio outputs may yield a situation that could be undesirable and possibly hazardous for a driver. By coordinating the number and sound level of audio outputs that simultaneously occur, such an audio overload may be avoided. A good example of such audio coordination would be for assembly 10 to cut down the radio volume upon receipt of an incoming call on cell phone accessory 22. A similar hierarchy of audio signals may be specified for all accessories that utilize audio input and/or output.

Different embodiments of the present invention may be constructed by combining selected of the above-referenced accessories into a unified module. For instance, a basic electronic assembly might include a mirror 12, photocell 14, radar detecting means 16, and optional automatic access control 18. An exemplary embodiment of such an electronic assembly is displayed in FIG. 2a. In other embodiments of the subject retrofit assembly, more electronic options may be available than those included in the assembly 10 of FIG. 2a. FIG. 2b illustrates an electronic assembly 10 similar to that of FIG. 2a, but including more accessories. Such exemplary assembly 10 includes a rearview mirror 12 with photocell 14, digital display 42, home access control 18, radar detector 16, and cell phone accessory 22 with appropriate audio interface.

Retrofit assembly 10 may or may not include rearview mirror 12. If such rearview mirror 12 is included in assembly 10, then it is assumed that any existing rearview mirror is replaced by assembly 10. If assembly 10 does not include a rearview mirror 12, then the assembly may be attached to or located near an existing rearview mirror in a vehicle. This enables assembly 10 to be placed in many different locations and potentially incorporate more than one wiring option to power such assembly 10. Examples of some potential locations and wiring options are depicted in FIG. 3. In preferred embodiments, assembly 10 is mounted in the same general location 30 within a vehicle as typical rearview mirrors. This position provides an ideal location and may also be easily connected to existing electrical connections 20 in this location. If electrical coupling 20 does not initially run to location 30 (or equivalently to existing rearview mirror 12), then an existing electrical connection may be rerouted to location 30. Another non-illustrated location for assembly 10 is on the top interior of the vehicle attached to the headboard of the vehicle. This location would easily comply with the option of connection 20 utilizing existing wiring to a rearview mirror.

An additional convenience of utilizing location 30 for assembly 10 is the ideal location for transmission and receipt of various communication signals used in accordance with the present invention. Radar system 16 and cell phone accessory 22 typically transmit and/or receive such wireless signals, and an ideal location such as 30 would facilitate the quality of such communication. Antennas may also be required for proper function of cell phone 22 or radar system 16. If appropriate, a single antenna could be provided to receive signals for many applications, such as cell phone 22, radar 16 and an existing car radio. When an antenna must be provided for use with cell phone accessory 22, the antenna could wrap around selected side(s) of assembly 10. By wrapping the antenna around assembly 10, the antenna has good functional position while remaining out of the way for a driver.

An assembly 10 without rearview mirror 12 can alternatively be placed in a location 36 that is near the dashboard of a vehicle interior, possibly below a radio 32 or other interactive assembly. When assembly 10 is in such second location 26, it may be electrically connected via existing or rerouted wiring 40 or it can alternatively be powered by an existing regulated power source such as that provided by a cigarette lighter. In the latter case, an adapter cord 30 would be provided with assembly 10 for convenient connection to alternative power source 38. Yet another option for providing power to electrical components of assembly 10 would be to include a battery in assembly 10 that provides a predetermined regulated voltage source.

A particular design objective of the present invention is to create an assembly 10 that is safe and convenient for the driver. Each of the described embodiments includes “display” elements and “interactive” elements. Display elements are the elements that do not require driver interaction, but that offer some sort of visual function to the driver. These elements typically include radar detecting means 16, digital display 42 and photocell 14. Interactive elements are the electrical accessories included in assembly 10 that require some sort of driver interaction. Interactive elements might include cell phone 48 (in combination with accessory 22) and home access control 18. In order to create a safe device, display elements and interactive elements are strategically positioned within assembly 10. As shown in FIG. 3, display elements are ideally located in a convenient line of sight for the driver and interactive elements are preferably located within easy reach of the driver. This positioning ensures that the driver does not divert more attention than required from the road.

While the present subject matter has been described in detail with respect to specific embodiments thereof, it will be appreciated that those skilled in the art, upon attaining an understanding of the foregoing may readily conceive of alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. A mirror-integrated module for mounting within a vehicle, said module comprising:
a rearview mirror;
a mirror reflectivity mechanism provided in conjunction with said rearview mirror and configured to adjust the amount of reflectivity of said rearview mirror based on the amount of ambient light provided thereto; and
a radar detector provided adjacent to said rearview mirror within said integrated module.

2. A mirror-integrated module as in claim 1, further comprising a home access controller configured to output a signal whereby accessibility to a home entrance is effected.

3. A mirror-integrated module as in claim 1, wherein said mirror reflectivity mechanism includes a photocell.

4. A mirror-integrated module as in claim 1, wherein said radar detector is configured to receive and process RF signals such that an output is provided upon detection of selected X-band, K-band, and Ka-band signals.

5. A mirror-integrated module as in claim 4, further comprising a digital display such that the output provided upon detection of selected signals by said radar detector comprises a visual output on said digital display.

6. A mirror-integrated module as in claim 5, wherein said digital display is further configured to output information corresponding to the current time, temperature and vehicle direction.

7. A mirror-integrated module as in claim 4, further comprising a speaker such that the output provided upon detection of selected signals by the radar detector comprises an audio output provided via said speaker.

8. A mirror-integrated module as in claim 1, wherein said home access controller is programmable such that the home access controller can be configured to output a frequency for opening and closing a user's garage door.

9. A mirror-integrated module as in claim 1, further comprising an electrical interface for receiving power from an existing power source of the vehicle in which the module is mounted.

10. A mirror-integrated module as in claim 1, wherein said radar detector is configured to receive and process laser-based signals.

11. A mirror-integrated module as in claim 1, further including a jamming device for blocking signals from radar systems attempting to monitor users of said module.

12. A multi-function electronic assembly for integrating with a rearview mirror in a vehicle interior, said electronic assembly comprising:
a mirror reflectivity mechanism configured to interface with a rearview mirror such that the amount of reflectivity of the rearview mirror is based on the amount of ambient light provided thereto;
a radar detector provided within said integrated module and configured to receive and process a predetermined range of RF signals and provide an output based on the received and processed signals;
a digital display such that the output provided upon detection of selected signals by said radar detector comprises a visual output on the digital display;
a speaker such that the output provided upon detection of selected signals by the radar detector comprises an audio output provided via said speaker; and
a home access controller configured to output a signal whereby accessibility to a home entrance is effected.

13. A multi-function electronic assembly as in claim 12, wherein said mirror reflectivity mechanism includes a photocell.

14. A multi-function electronic assembly as in claim 12, wherein said radar detector is configured to receive and process RF signals such that an output is provided upon detection of selected X-band, K-band, and Ka-band signals.

15. A multi-function electronic assembly as in claim 12, wherein said digital display is further configured to output information corresponding at least one characteristic selected from the group consisting of the current time, current temperature, vehicle location, vehicle direction, vehicle speed, and vehicle fuel level.

16. A multi-function electronic assembly as in claim 12, wherein said home access controller is programmable such that the home access controller can be configured to output a frequency for opening and closing a user's garage door.

17. A multi-function electronic assembly as in claim 12, further comprising a microphone audio input interfaced with said home access controller such that voice commands inputted to said microphone effect the accessibility to a home entrance.

18. A multi-function electronic assembly as in claim 12, further comprising an electrical interface for receiving power from a power source within the vehicle provided to the rearview mirror with which said electronic assembly is integrated.

19. A modular assembly suitable for retrofit installation within a vehicle, said modular assembly comprising:
a rearview mirror;
a mirror reflectivity mechanism provided in conjunction with said rearview mirror and configured to adjust the amount of reflectivity of said rearview mirror based on the amount of ambient light provided thereto;
a radar detector provided within said integrated module and configured to receive and process a predetermined range of RF signals and provide an output based on the received and processed signals;
a digital display such that the output provided upon detection of selected signals by said radar detector comprises a visual output on the digital display;
a speaker such that the output provided upon detection of selected signals by the radar detector comprises an audio output provided via said speaker;
a home access controller configured to output a signal whereby accessibility to a home entrance is effected; and
an audio recorder for receiving input from a microphone audio input, whereby stored signals recorded by said audio recorder may be outputted by said speaker.

20. A modular assembly as in claim 19, wherein said mirror reflectivity mechanism includes a photocell.

21. A modular assembly as in claim 19, wherein said radar detector is configured to receive and process RF signals such that visual and audio outputs are provided upon detection of selected X-band, K-band, and Ka-band signals.

22. A modular assembly as in claim 19, wherein said digital display is further configured to output information corresponding at least one characteristic selected from the group consisting of the current time, current temperature, vehicle location, vehicle direction, vehicle speed, and vehicle fuel level.

23. A modular assembly as in claim 19, wherein said home access controller is programmable such that the home access controller can be configured to output a frequency for opening and closing a user's garage door.

24. A modular assembly as in claim 19, further comprising a microphone audio input interfaced with said audio recorder and with said home access controller such that voice commands inputted to said microphone effect the accessibility to a home entrance.

25. A modular assembly as in claim 19, further comprising an electrical interface for connecting with a cellular phone whereby hands-free cellular communication is facilitated via said microphone audio input and via said speaker.
